(19) United States
(12) Patent Application Publication
(10) Pub. No.: US 2016/0295989 A1
(43) Pub. Date: Oct. 13, 2016

(54) ARTIFICIAL NAILS WITH DISPLAYS

(71) Applicant: Q-TEE PRODUCT DESIGN, LLC, Oakland,, CA (US)

(72) Inventors: Quadir Hakeem, Oakland, CA (US); Thaillia Woods, Antioch, CA (US)

(21) Appl. No.: 14/770,583

(22) PCT Filed: Jan. 9, 2015
(86) PCT No.: PCT/US15/10881

§ 371 Date: Aug. 26, 2015

Related U.S. Application Data
(63) Continuation-in-part of application No. 14/295,682, filed on Jun. 4, 2014, now abandoned.
(60) Provisional application No. 61/925,356, filed on Jan. 9, 2014.

(51) Int. Cl. A45D 31/00; G02F 1/167; G09G 5/12; G09G 5/02; A45D 44/00; G09G 5/00

(52) U.S. Cl. CPC A45D 31/00; A45D 44/005; G09G 5/003; G09G 5/12; G09G 5/02; G02F 1/167; H04B 7/26

(57) ABSTRACT

A device includes an artificial nail (1400). The artificial nail (1400) includes a display (1405) that displays designs using electronic paper or electrophoretic ink.

### CROSS-REFERENCE TO RELATED APPLICATIONS

The present application is a continuation in part of U.S. patent application Ser. No. 14/295,682, filed on Jun. 4, 2014, which claims the benefit of U.S. Provisional Patent Application Ser. No. 61/925,356, filed on Jan. 9, 2014, all of which are fully incorporated by reference for all purposes.

### TECHNICAL FIELD

Generally, the present disclosure relates to artificial nails. More particularly, the present disclosure relates to artificial nails with displays.

### BACKGROUND

In the present disclosure, where a document, an act and/or an item of knowledge is referred to and/or discussed, then such reference and/or discussion is not an admission that the document, the act and/or the item of knowledge and/or any combination thereof was at the priority date, publicly available, known to the public, part of common general knowledge and/or otherwise constitutes prior art under the applicable statutory provisions; and/or is known to be relevant to an attempt to solve any problem with which the present disclosure may be concerned with. Further, nothing is disclaimed.

A person typically applies a nail polish onto the person's fingernail for a decorative purpose. Such application often entails many implements, such as a nail polish container, a nail polish remover container, a top coat container, a base coat container, a nail polish remover pad, a nail scissors unit, a nail clipper, a nail file, and so forth. The implements can inefficiently occupy valuable storage space, such as in a purse, a home, an automobile, and so forth. Furthermore, the implements can become misplaced, which can be time consuming and/or expensive for the person to replace. Also, using some of the implements often results in noxious fumes, flammable conditions, and/or spillage onto the person's belongings, such as a furniture item and/or a clothing item, which can be unhealthy, dangerous, time consuming and/or expensive for the person to deal with. Moreover, purchasing the implements can be expensive and/or time consuming for the person, which can limit the person's ability to change an appearance of the person's fingernail, especially at will. Further, the person can have limited options in color, design, and/or other decoration from which to choose when changing the appearance of the person's fingernail. Additionally, the nail polish frequently chips and fades within a short time period from application onto the person's fingernail, thereby exposing the person's unpolished fingernail underneath. Although the person can self-reapply the nail polish onto the fingernail, such self-reapplication is expensive and/or time consuming for the person, especially when the person is attending an important event.

Although the person can have another individual, such as a nail technician at a nail salon, apply the nail polish onto the person's fingernail, similar concerns exist for at least one of the person and the individual. In addition, the person can struggle to find the individual with an appropriate skill set required to execute the person's desired look, especially when the look is intricately designed. Moreover, even assuming that such individual can be found, then the person is frequently unable to schedule the individual due to a scheduling conflict in at least one of the person's schedule and the individual's schedule. Furthermore, if the individual is the technician, then a financial expense of using the technician often prohibits the person from using the individual, which can limit the person's ability to change the appearance of the person's fingernail, especially at will.

When the person desires to apply the nail polish onto the person's toenail, whether additionally and/or alternatively, whether personally and/or impersonally, then the person is also faced with at least one of the above.

### BRIEF SUMMARY

The present disclosure addresses at least one of the above. However, the present disclosure may prove useful in addressing other problems and deficiencies in a number of technical areas. Therefore, the claims, as recited below, should not necessarily be construed as limited to addressing any of the particular problems or deficiencies discussed herein.

According to an example embodiment of the present disclosure a device is provided. The device includes an artificial nail. The nail includes a display and a power source powering the display.

According to another example embodiment of the present disclosure a system is provided. The system includes a computer receiving a user input. The system also includes an artificial nail including a display and a power source powering the display. The computer communicates with the nail such that the display displays visual information based at least in part on the input.

According to yet another example embodiment of the present disclosure a method is provided. The method includes receiving a user input via a computer. The method further includes communicating the input to an artificial nail. The nail includes a display and a power source powering the display. The method includes displaying visual information via the display. The information is based at least in part on the input.

According to one aspect, the present technology is directed to a device, such as an artificial nail with a digital display. The device comprises: (a) a body configured to mate with a fingernail of a user; and (b) a display associated with an upper surface of the body that uses electrophoretic ink or electronic paper to display designs.

According to another aspect, the present technology is directed to a system, comprising: (a) a nail covering device, comprising: (i) a body configured to mate with a fingernail of a user; (ii) a display associated with an upper surface of the body, the display using electrophoretic ink to display designs; and (iii) a receiving unit for communicating with a design transfer device; and (b) the design transfer device comprising: (I) a housing that comprises a processing unit and memory unit for storing at least one design, wherein the design transfer device is configured to transmit the at least one design to the nail covering device.

According to another aspect, the present technology is directed to a system, comprising: (a) a nail covering device, comprising: (i) a body configured to mate with a fingernail of a user; (ii) a display associated with an upper surface of the body, the display using electrophoretic ink to display designs; and (iii) a receiving unit for communicating with a design transfer device; (b) the design transfer device comprising: (i) a housing that comprises a processing unit and memory unit for storing at least one design, wherein the design transfer device is configured to transmit the at least one design to the nail covering device; and (c) a server that communicatively couples with the design transfer device, the server storing a plurality of designs, the least one design being one of the plurality of designs, wherein a user causes the at least one design to be transferred from the server to the design transfer device using an application executing on a mobile device associated with the user.

According to yet another aspect, the present technology is directed to a design transfer device comprising: a housing that comprises a processing unit and memory unit for storing at least one design, wherein the design transfer device is configured to transmit the at least one design to a receiving unit of a nail covering device for displaying said design on an electrophoretic ink or electronic paper display carried on said nail covering device.

The present disclosure may be embodied in the form illustrated in the accompanying drawings. Attention is called to the fact, however, that the drawings are illustrative. Variations are contemplated as being part of the disclosure, limited only by the scope of the claims. The above and other features, aspects and advantages of the present disclosure will become better understood to one skilled in the art with reference to the following drawings, detailed description and appended claims.

According to yet another aspect, the present technology is directed to one or more devices or methods comprising one or more of the structural, functional, or ornamental features described herein.

### BRIEF DESCRIPTION OF THE DRAWINGS

The accompanying drawings illustrate example embodiments of the present disclosure. Such drawings are not to be construed as necessarily limiting the present disclosure. Like numbers and/or similar numbering scheme can refer to like and/or similar elements throughout.

FIG. 1 shows an example embodiment of an artificial nail in wireless communication with a mobile phone according to the present disclosure.

FIG. 2 shows an example embodiment of an artificial nail receiving a wireless signal from at least one computer according to the present disclosure.

FIG. 3 shows an example embodiment of an artificial nail charged in a wired manner according to the present disclosure.

FIG. 4 shows an example embodiment of a plurality of artificial nails displaying one design according to the present disclosure.

FIG. 5 shows an example embodiment of a plurality of artificial nails displaying a plurality of different designs according to the present disclosure.

FIG. 6 shows another example embodiment of a plurality of artificial nails displaying a plurality of different designs according to the present disclosure.

FIG. 7 shows still another example embodiment of a plurality of artificial nails displaying a plurality of different designs according to the present disclosure.

FIG. 8 shows an example embodiment of an artificial nail having a photovoltaic cell according to the present disclosure.

FIG. 9 shows an example embodiment of an artificial nail cover having an activation switch according to the present disclosure.

FIG. 10 shows an example embodiment of a charging station wirelessly charging an artificial nail according to the present disclosure.

FIG. 11 shows an example embodiment of an artificial nail having a hanging line according to the present disclosure.

FIG. 12 shows an example embodiment of a case storing an artificial nail for charging according to the present disclosure.

FIG. 13 shows a schematic diagram of an example embodiment of an artificial nail according to the present disclosure.

FIGS. 14A-H collectively illustrate an example embodiment of an artificial nail according to the present disclosure, with FIGS. 14G and 14H illustrating schematic diagrams of embodiments of artificial nail devices.

FIGS. 15A-G collectively illustrate an example embodiment of a design transfer device according to the present disclosure, with FIG. 15G illustrating a schematic diagram of an embodiment of a design transfer device.

FIG. 16 is a schematic diagram of an example embodiment of a system for practicing aspects of the present technology.

### DETAILED DESCRIPTION OF THE PREFERRED EMBODIMENTS

The present disclosure is now described more fully with reference to the accompanying drawings, in which example embodiments of the present disclosure are shown. The present disclosure may, however, be embodied in many different forms and should not be construed as necessarily being limited to the example embodiments set forth herein. Rather, these example embodiments are provided so that the disclosure is thorough and complete, and fully conveys the concepts of the present disclosure to those skilled in the art. Also, features described with respect to certain example embodiments may be combined in and/or with various other example embodiments. Different aspects and/or elements of example embodiments, as disclosed herein, may be combined in a similar manner. Further, at least some example embodiments may individually and/or collectively be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity, at least as described herein, in any manner, irrespective of the at least one entity have any relationship to the subject matter of the present disclosure.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three dimensional (3D) printing, laser cutting, computer numerical control (CNC) routing, milling, pressing, stamping, vacuum forming, hydroforming, injection molding, lithography and/or others.

Any and/or all elements, as disclosed herein, can include, whether partially and/or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

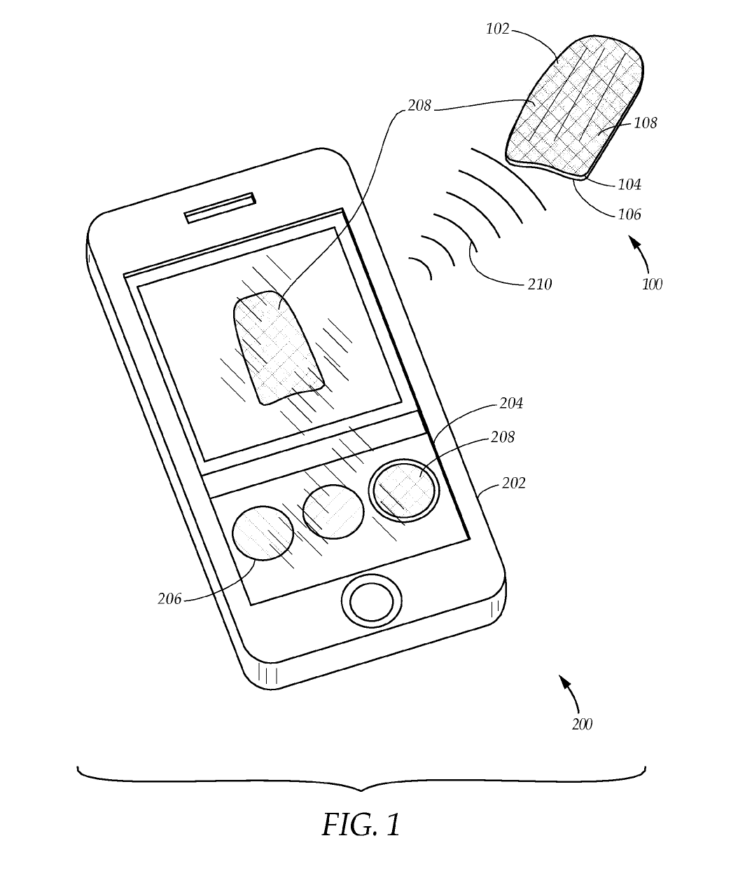

FIG. 1 shows an example embodiment of an artificial nail in wireless communication with a mobile phone according to the present disclosure.

An artificial nail 100 includes a body 102 having an upper side 104, a lower side 106, and a plurality of sidewalls spanning therebetween. The side 104 is visible to others when the nail 100 is worn. The side 106 at least partially faces a wearer's fingernail when the nail 100 is worn.

The body 102 attempts to visually mimic an appearance of the fingernail, but in other embodiments, the body 102 avoids visually mimicking the appearance of the fingernail. The body 102 is shaped and sized as the fingernail, such as in a nail form, but in other embodiments, the body 102 is shaped and sized in a nail tip form. However, note that the body 102 can be shaped in any shape, such as a circle, a star, a triangle, a rectangle, and so forth. The body 102 includes plastic, but in other embodiments, the body 102 includes another suitable material, such as metal, glass, wood, acrylic, and rubber. The side 104 and the side 106 are similarly shaped and sized, but in other embodiments, the side 104 and the side 106 differ from each other in at least one of shape and size.

The side 106 is directly coupled to the fingernail, but in other embodiments, the side 106 is indirectly coupled to the fingernail. The side 106 is coupled to the fingernail via an adhesive, such as a glue, an adhesive coating, a resin, a tape, and other suitable adhesive technology. Such adhesive can be waterproof. In other embodiments, the side 106 is coupled to the fingernail via another technology, which can include a magnet, a clamp, a hook-and-loop fastener, a male-female mater, an interlocker, and other suitable technologies. Note that the fingernail can be of any finger of a male wearer and/or a female wearer, whether an infant, a toddler, a teen, an adult, and an elderly person. Also, note that the side 106 can be coupled to another artificial nail, whether directly and/or indirectly. For example, the side 106 can be directly coupled to the another artificial nail when the another artificial nail is already coupled to the fingernail. Further, note that the side 106 is coupled to at least an outer portion of the fingernail, which is visible to a naked eye of the wearer. However, in other embodiments, the side 106 is coupled to another portion of the fingernail, such as underneath the fingernail. In yet other embodiments, the body 102 is coupled to the fingernail without using the side 106, such as via the side 104, a sidewall of the body 102, and another suitable methodology.

The body 102 includes a power source unit, a processing unit, a memory unit, and a receiving unit. The power source unit includes at least one of a battery and a capacitor. The power source unit can be rechargeable, such as in at least one of a wired manner and a wireless manner. The power source unit can be selectively removable from the body 102, such as for repair, replacement, and so forth. The processing unit includes at least a single core chip. The processing unit is powered via the power source unit. The memory unit includes nonvolatile memory hardware, such as a flash memory chip. The memory unit is operably coupled to the processing unit, such as via wired contact. The memory unit can be powered via the power source unit. The receiving unit is operably coupled to the processing unit, such as via wired contact. The receiving unit can be powered via the power source unit. The receiving unit is configured for at least receiving a wireless communication sent via at least one of a radio technology, an optic technology, a sound technology, and an induction technology. For example, the receiving unit, such as a receiver, a transceiver, and so forth, can receive a wireless communication, such as via an antenna, a light emitting diode (LED), and so forth, based on a short-range wireless communication protocol, such as Bluetooth®, infrared, and so forth. Also, for example, the receiving unit can be configured for at least receiving a wireless communication based on a Institute of Electrical and Electronics Engineers (IEEE) 802.11 standard. Further, for example, the receiving unit can be configured for at least a wireless communication with a cell site. Moreover, for example, the receiving unit can be configured for at least a wireless communication with an orbiting satellite.

The side 104 includes a display 108 displaying visual information, such as an ornamental pattern for a decorative purpose. The display 108 is electronic, but in other embodiments, the display 108 is analog. The display 108 can be a liquid crystal display (LCD), a plasma display, an electrophoretic display, a light emitting diode (LED) display, and so forth. The display 108 can be of any shape, such as a rectangle, a triangle, a square, a circle, an oval, a pentagon, an alphanumeric character, a symbol, and so forth. Although the display 108 is a single display, in other embodiments, the display 108 is defined via a plurality of sub-displays 108. Also, note that more than one display 108 can be used, whether identical to and/or different from the display 108 in any manner, such as size, shape, function, and so forth. Note that such use can be dependent on each other, with one master display 108 and one slave display 108, and/or independent of each other, with each of the displays 108 operating independently from each other, such as via displaying different visual information simultaneously. Note that such displays 108 can be oriented in any way with respect to each other. Also, note that such displays 108 can be immediately adjacent to each other or spaced apart from each other, such as via a strip on the side 104 interposed between such displays 108, where the strip spans between the sidewalls on the side 104.

The display 108 is bezel-free, but in other embodiments, the display 108 at least partially includes a bezeled portion. The display 108 fully covers the side 104. However, in other embodiments, the display 108 less than fully covers the side 104 in any orientation, whether longitudinally, laterally, and/or diagonally, in any shape. For example, the wearer can apply a nail polish onto those portions of the side 104 which lack the display 108.

The display 108 is powered via the power source. The display 108 is operably coupled to the processor, such as via wired contact. The display 108 displays in at least two dimensions, such as a horizontal X-axis and a vertical Y-axis. The display 108 displays in at least one color, such as a monochrome setting, a grayscale setting, and/or a color setting. Note that such color selection can be manufacturer restricted and/or wearer selectable. The display 108 displays according to a resolution sufficiently high such that the display 108 appears as a fingernail with a nail polish thereon to a nearby casual observer. For example, such resolution can be at least 720 pixels i.e. 1280×720p: 921,600 pixels per frame. The display 108 is at least one of convex, concave, and flat. The display 108 is at least one of a matte display and a glossy display. The display 108 can be coated with an anti-reflective coating. The display 108 is at least one waterproof, such as via a rubber seal, scratch-proof, such as via an anti-scratch coating, and shock-proof, such as via an internal shock absorber. The display 108 is not touch enabled. However, in other embodiments, the display 108 is touch-enabled, such as via at least one of a resistive technology, an acoustic technology, a capacitative technology, an infrared technology, an optical technology, and dispersive technology. For example, the display 108 is touch enabled such that displayed visual information can be wearer manipulated via a single gesture and/or a multi-touch gesture, such via the user's finger and/or a stylus pen. Note that the display 108 can display any type of visual information. For example, the display 108 can display at least one of a color, a pattern, a shape, a logo, a design, a symbol, an alphanumeric character, a still image, a video, an animation, a screensaver, and so forth. Also, note that the nail 100 can self-generate images based on artificial intelligence, local context conditions, and so forth. Some examples include ambient lighting conditions, such as automatically detected via an onboard light sensor of the nail 100 and/or an onboard camera of the nail 100. Other examples include a personal preference memorialized in the memory unit, a frequency of use analysis performed via the processor, and so forth. In other embodiments, the display 108 is sufficiently bright for use as at least one of a flashlight and a camera flash, whether displaying an ornamental pattern or displaying some other visual information, such as a white light. For example, the display 108 can output the white light when the nail 100 is synchronized with a camera, a camera phone, a camera tablet, and so forth.

In other embodiments, the display 108 is configured for displaying visual information mechanically. For example, the display 108 can be defined via a plurality of shutter panels, where each of the panels includes a surface with some visual information depicted thereon, whether electronically and/or mechanically. For instance, such panels can be adjacent to each other, flush with each other, and square shaped. Together, such surfaces with such information form a single image when the surfaces are movably positioned accordingly. Note that the body 102 includes a moving mechanism configured to rotate the panels between a plurality of positions. Such mechanism is operably coupled to the processor, such as via wired contact, and powered via the power source. In other embodiments, at least one of such panels can be shaped as a polyhedron, such as an octagonal prism.

In other embodiments, the side 106 includes another display 108, such as described above. Such display 108 can be operate dependent on and/or independent from the display 108 on the side 104. For example, the display 108 on the side 104 can display a color, while the display 108 on the side 106 can display a pattern.

In other embodiments, for enhanced safety, such as for avoidance of at least one of overheating and electric shock, the body 102 can include at least one of a thermal insulator and an electric insulator. The body 102 includes at least one of a beveled portion and a chamfered portion, which can include the display 108. The body 102 can be at least one of waterproof, such as via a rubber seal, scratch-proof, such as via an anti-scratch coating, and shock-proof, such as via an internal shock absorber. Note that the nail 100 is configured for at least one of a single use and a plurality of uses.

In other embodiments, the body 102 includes a microphone for receiving a vocal command from the wearer on what visual information to display via the display 108. The body 102 also includes a voice command logic, whether hardware based and/or software based, such as stored in the memory unit, processing the vocal command, as received via the microphone, for such displaying. The microphone is operably coupled to the processing unit, such as via wired contact. For example, based on vocal input via the microphone, the processing unit instructs the display 108 to display based on the vocal input, which can be without using the receiving unit and/or without the receiving unit. The microphone is powered via the power source. The microphone can be positioned on at least one of the sidewalls, the side 104, and the side 106. The voice command can be natural language based and/or preset command based.

In other embodiments, the body 102 includes a speaker for outputting a sound to the wearer, such as when playing a video with audio, streaming from another device, and so forth. The speaker is operably coupled to the processing unit, such as via wired contact. The speaker is powered via the power source. The speaker can be positioned on at least one of the sidewalls, the side 104, and the side 106.

In other embodiments, the power source is rechargeable via body heat, such as via a thermoelectric generator.

In other embodiments, the nail 100 operates in an awake mode and an asleep mode. For example, the display 108 can be placed into the asleep mode for hibernation after a time period of inactivity. Likewise, the display 108 can be woken up from the hibernation via a command, such as a wireless signal from another device.

In other embodiments, the nail 100 houses a vibrator operably coupled to the processing unit, such as via wired contact. The vibrator is configured to vibrate upon an action, such as when the display 108 changes visual information. The vibrator is operably coupled to the processing unit, such as via wired contact. The vibrator is powered via the power source.

In other embodiments, the nail 100 houses a graphics card operably coupled to the processing unit, such as via wired contact. The card is operably coupled to the display 108, such as via wired contact. The card assists the display 108 in displaying visual information. The card is powered via the power source. In other embodiments, the display 108 can include the card.

Note that the nail 100 can also be configured for placing over a toenail. For example, one type of the nail 100 can be configured for placing over the fingernail, while another type of the nail 100 can be configured for placing over the toenail. However, note that some embodiments can allow for the nail 100 to be configured for placing over the toenail and the fingernail.

A mobile phone 200 includes a body 202 and a display 204. The phone 200 runs a software application, which displays a graphical user interface (GUI) via the display 204. The GUI depicts a plurality of icons 206 corresponding to a plurality of ornamental patterns 208. A right pattern 208 is currently selected via having a circle around the right pattern 208. Resultantly, above the icons 206, the GUI depicts an image of the nail 100 displaying the right pattern 208 on the display 108. Likewise, the display 108 on the nail 100 depicts the right pattern 208. Note that the application can be local to the phone 200, such as downloaded from an app store, and/or the application be remote to the phone 200, such as network browser operated, for instance online-based. Also, note that the GUI is one manner of performing such functionality and other suitable GUIs can be used, whether additionally and/or alternatively.

In an example mode of operation, the wearer adheres the nail 100 onto the wearer's fingernail via the side 106 such that the side 104 is visible to the naked eye of the wearer. The wearer pairs the phone 200 to the nail 100 for short range wireless communication. The wearer operates the phone 200 to select one of the icons 206. The phone 200 wirelessly communicates the wearer's selection to the nail 100. The nail 100 displays the pattern 208 via the display 108. Note that the pattern 208 displayed via the display 108 can be selected randomly, whether via the module 112 of the nail 100 and/or the phone 200 via the application. Such random selection can be based on a plurality of locally stored images and/or a plurality of remotely stored images, whether local to the nail 100 and/or the phone 200, whether remote to the nail 100 and/or the phone 200. Also, the nail 100 can be configured for automatically iterating through a sequence of the patterns 208, such as for a wearer selected time period.

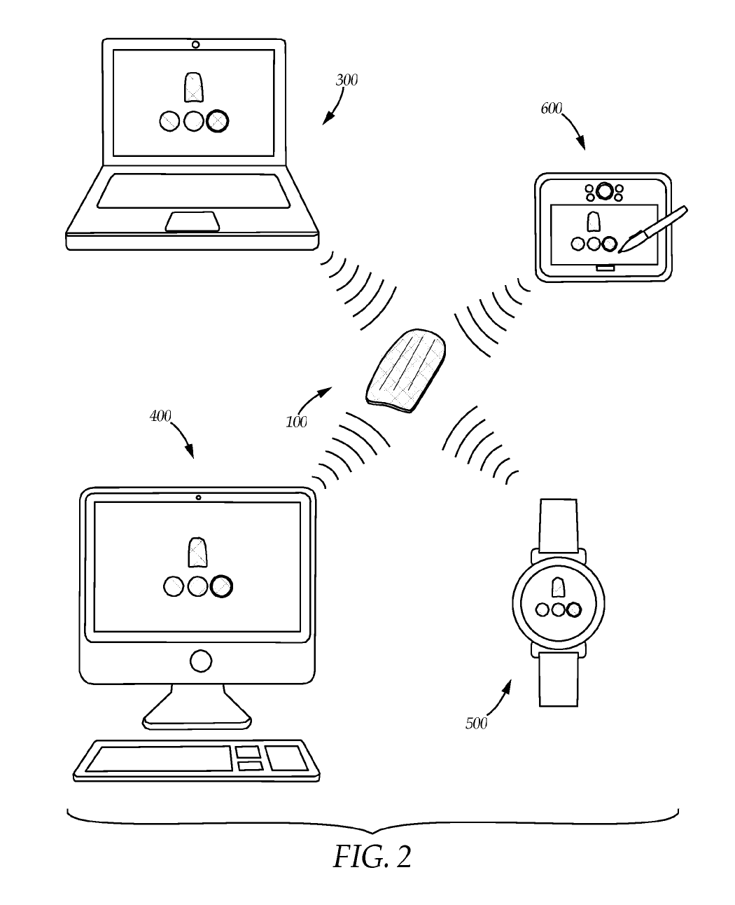

FIG. 2 shows an example embodiment of an artificial nail receiving a wireless signal from at least one computer according to the present disclosure. Some elements of this figure are described above. Thus, same reference characters identify identical and/or like components described above and any repetitive detailed description thereof will hereinafter be omitted or simplified in order to avoid complication.

The nail 100 is configured for receiving a wireless signal from at least one of a laptop computer 300, a desktop computer 400, a watch 500, and a tablet computer 600. Such signal, as described above, allows for display of the ornamental pattern 208 via the display 108 on the nail 100. Note how at least one of the laptop computer 300, the desktop computer 400, the watch 500, and the tablet computer 600 displays the GUI depicting the icons 206 corresponding to the patterns 208. However, also note that other GUIs can also be used, whether identical to and/or different from each other. Further, note that such communication can be synchronous and/or asynchronous. Note that watch 500 can be digital and/or analog.

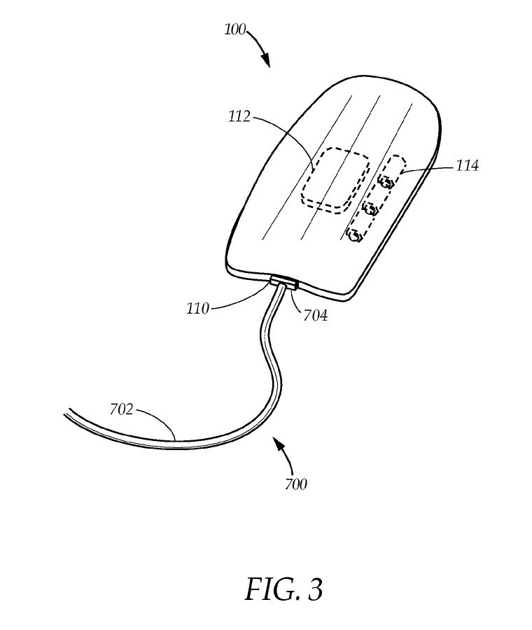

FIG. 3 shows an example embodiment of an artificial nail charged in a wired manner according to the present disclosure. Some elements of this figure are described above. Thus, same reference characters identify identical and/or like components described above and any repetitive detailed description thereof will hereinafter be omitted or simplified in order to avoid complication.

The body 102 includes a port 110 within one of the sidewalls. Note that more than one port 110 is possible, whether within one of the sidewalls and/or within a plurality of the sidewalls, whether identical and/or different from each other. For example, the port 110 can be a Firewire® port, a Thunderbolt® port, a universal serial bus (USB) port, and so forth. The port 110 can be configured for water resistance when the body 102 is exposed to water. For example, such resistance can be in under ten feet of water.

The body 102 houses a hardware module 112 containing at least the processing unit, the memory unit, and the receiving unit. Note that module 112 can include other components, as described herein, such as the graphics card. Although the module 112 is non-removable from the body 102, in other embodiments, the module 112 is removable from the body 102, such as for repair, replacement, upgrades, and so forth.

The body 102 houses a plurality of cylindrical batteries 114, which power the module 112 and the display 108. For example, the batteries 114 can be lithium based. In other embodiments, the body 102 houses only one of the batteries 114 powering the module 112 and the display 108. Also, note that the batteries 114 can be shaped non-cylindrically as well, such as a cuboid, a sphere, and so forth.

A charging cable 700 includes a cord 702 and a plug 704. The port 110 receives the plug 704 such that the port 110 and the plug 704 are in male-female coupling relationship. Note that the cable 700 can also feed data, such as visual information, video, audio, and so forth, to the memory unit of the module 112. Also, note that the charging and/or data transfer can be for many types of peripherals, whether unidirectional and/or bidirectional. Such computer peripherals include, but are not limited to a mobile phone, a desktop computer, a wearable computer, a monitor, a webcam, a keyboard, a digital camera, a printer, a portable media player, a personal computer, a smartphone, a personal digital assistant (PDA), a video game console, and other electronic devices.

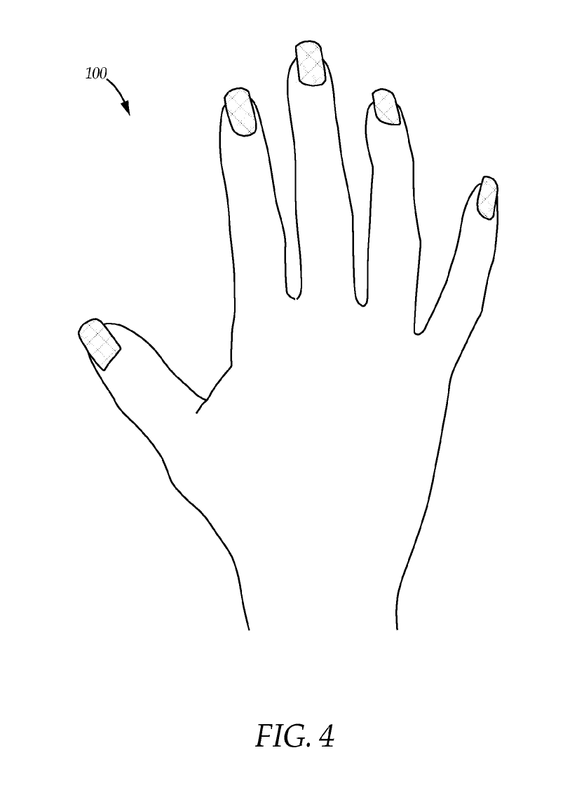

FIG. 4 shows an example embodiment of a plurality of artificial nails displaying one design according to the present disclosure. Some elements of this figure are described above. Thus, same reference characters identify identical and/or like components described above and any repetitive detailed description thereof will hereinafter be omitted or simplified in order to avoid complication.

The wearer's right hand has five fingernails, each of which is wearing the nail 100 via adhesion with the side 104 facing the wearer and the side 106 facing the fingernail. The wearer operates the GUI of the application running on the phone 200 such that the nails 100 display an identical ornamental pattern on the displays 108. Note that such operation can be on an individual basis, such as nail-by-nail, and/or a group basis, such as concurrently for at least two of the nails 100. For example, the GUI can depict a hand with five fingers such that the wearer can select at least one of the fingers for at least one of image selection and image setting based on the selection.

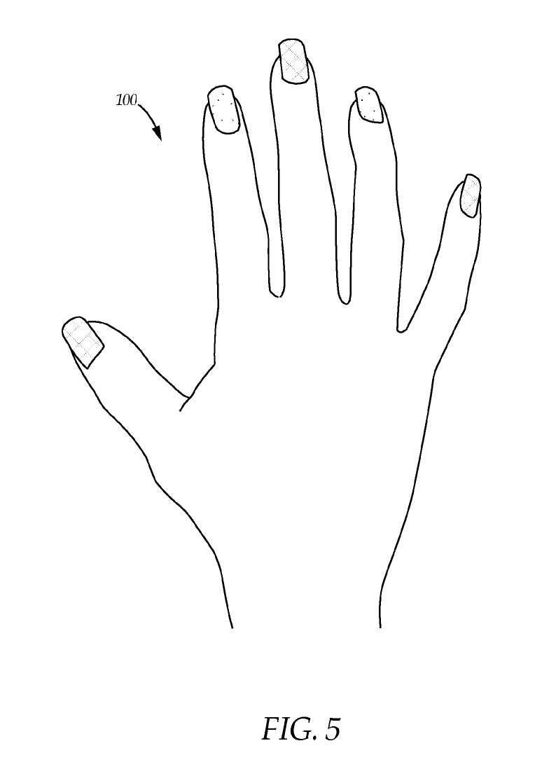

FIG. 5 shows an example embodiment of a plurality of artificial nails displaying a plurality of different designs according to the present disclosure. Some elements of this figure are described above. Thus, same reference characters identify identical and/or like components described above and any repetitive detailed description thereof will hereinafter be omitted or simplified in order to avoid complication.

Unsatisfied with the ornamental pattern of FIG. 4, the wearer operates the GUI of the application running on the phone 200 such that the nails 100 on an index finger and on a ring finger display an ornamental pattern different from the other fingers. Note that such changes can be performed at will.

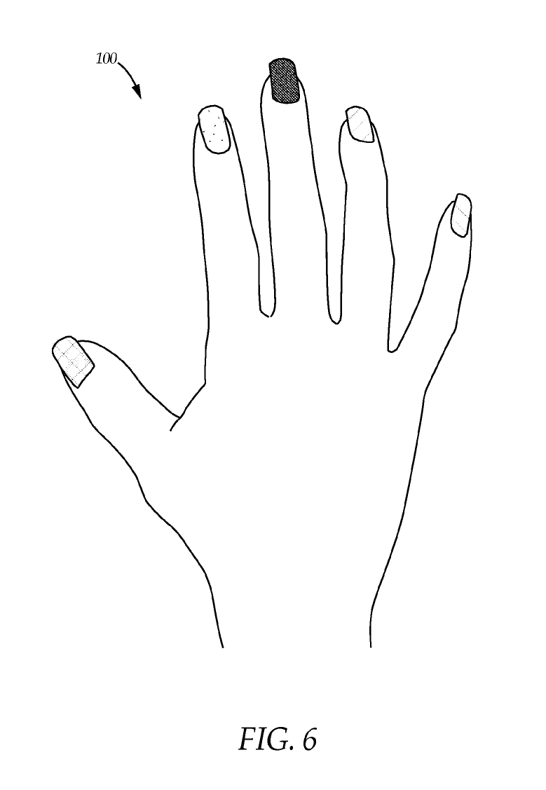

FIG. 6 shows another example embodiment of a plurality of artificial nails displaying a plurality of different designs according to the present disclosure. Some elements of this figure are described above. Thus, same reference characters identify identical and/or like components described above and any repetitive detailed description thereof will hereinafter be omitted or simplified in order to avoid complication.

Again unsatisfied with the ornamental patterns of FIG. 5, the wearer again operates the GUI of the application running on the phone 200 such that the nails 100 on a middle finger, the ring finger, and a little finger display an ornamental pattern different from the index finger and the ring finger, as described above. Note that such changes can be performed at will.

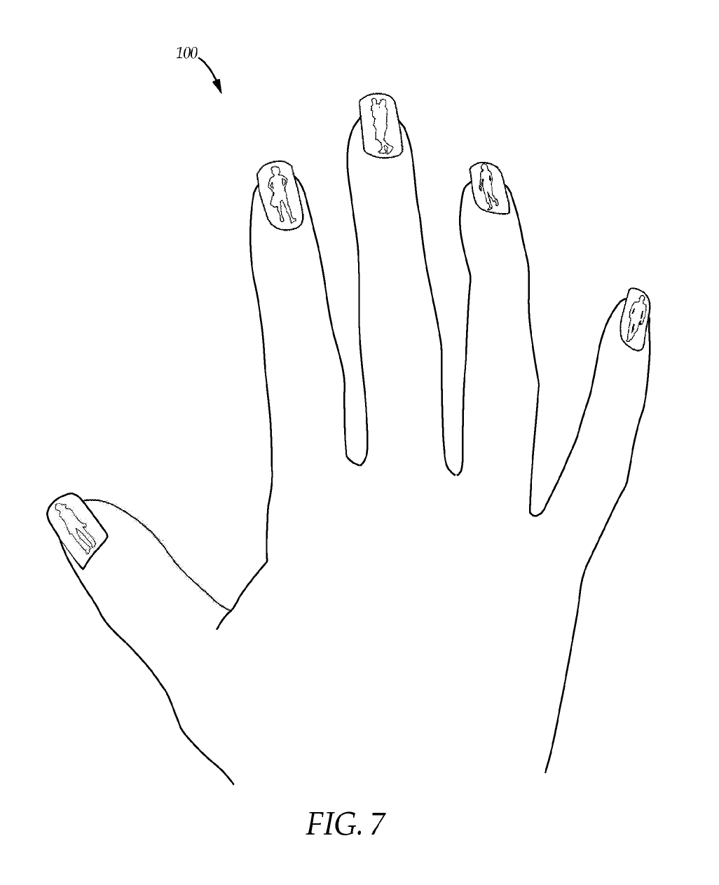

FIG. 7 shows still another example embodiment of a plurality of artificial nails displaying a plurality of different designs according to the present disclosure. Some elements of this figure are described above. Thus, same reference characters identify identical and/or like components described above and any repetitive detailed description thereof will hereinafter be omitted or simplified in order to avoid complication.

Again unsatisfied with the ornamental patterns of FIG. 6, the wearer again operates the GUI of the application running on the phone 200 such that the nails 100 display images, such as photographs. Note that any type of visual information can be displayed.

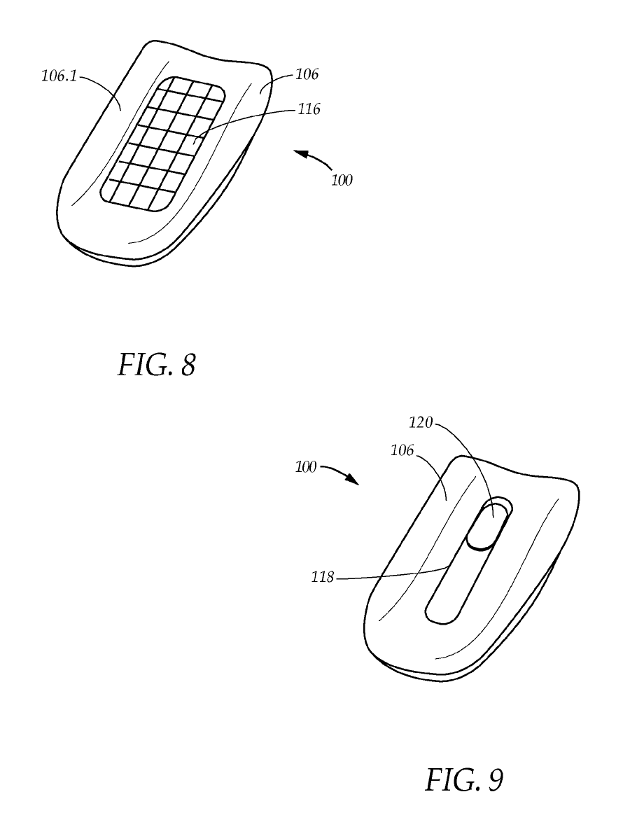

FIG. 8 shows an example embodiment of an artificial nail having a photovoltaic cell according to the present disclosure. Some elements of this figure are described above. Thus, same reference characters identify identical and/or like components described above and any repetitive detailed description thereof will hereinafter be omitted or simplified in order to avoid complication.

The side 106 includes a pair of opposing side ridges 106.1 longitudinally extending along the body 102. The body 102 includes a photovoltaic cell 116 extending between the ridges 106.1 along the body 102. The cell 116 can be of any shape. The cell 116 recharges the power source, such as the batteries 114. The cell 116 is a crystalline silicon cell, but can be of any suitable type. Note that the body 102 can include a plurality of the cells 116. In other embodiments, the side 104 and/or at least one of the sidewalls includes the cell 116.

FIG. 9 shows an example embodiment of an artificial nail cover having an activation switch according to the present disclosure. Some elements of this figure are described above. Thus, same reference characters identify identical and/or like components described above and any repetitive detailed description thereof will hereinafter be omitted or simplified in order to avoid complication.

The side 106 includes a turn on/off mechanism, which turns on the nail 100 and turns off the nail 100. The mechanism includes a defined path 118 and a switch 120 traveling the path 118 between a turn on position and a turn off position. Note that other types of such mechanisms can be used as well, such as a button, a touchscreen, and so forth.

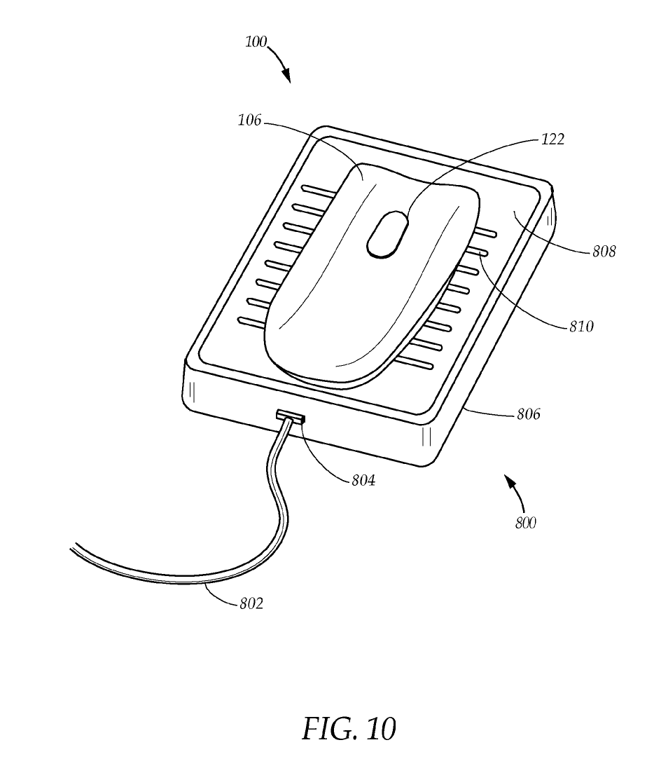

FIG. 10 shows an example embodiment of a charging station wirelessly charging an artificial nail according to the present disclosure. Some elements of this figure are described above. Thus, same reference characters identify identical and/or like components described above and any repetitive detailed description thereof will hereinafter be omitted or simplified in order to avoid complication.

A wireless charging station 800 includes a charging cord 802, a plug 804, and a base 806. The base 806 includes an upper side 808 including a plurality of induction charging couplings 810 extending thereon. Each of the coupling 810 includes an induction coil creating an alternating electromagnetic field from within base 806. The station 800 functions as a wireless energy sender.

The nail 100 includes an induction charging element 122 extending along the side 106. The nail 100 is resting on the side 808 for wireless charging via an electromagnetic field for energy transfer to the power source, such as the batteries 114. The element 122 includes an induction coil, which receives power from the electromagnetic field for electrical current conversion to charge the power source source. The element 122 functions as a wireless energy receiver. Note that the nail 100 can transfer data, while recharging, whether in a wired manner and/or a wireless manner.

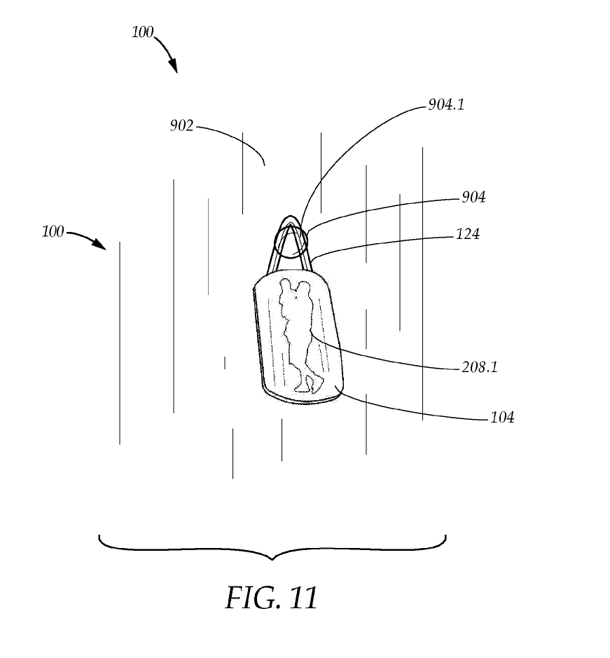

FIG. 11 shows an example embodiment of an artificial nail having a hanging line according to the present disclosure. Some elements of this figure are described above. Thus, same reference characters identify identical and/or like components described above and any repetitive detailed description thereof will hereinafter be omitted or simplified in order to avoid complication.

The display 108 on the side 104 of the nail 100 displays visual information 208.1, which is a photo, as selected via the phone 200. The nail 100 includes a hanging line 124, which is coupled to the side 106 on both ends. The line 124 is a cord, but can be a rope, a cable, a chain, and so forth. Note that the line 124 can be coupled in other places, such as at least one of the sidewalls, the side 104, and so forth. The line 124 is plastic, but can include metal, wood, rubber, glass, and other suitable materials. The line 124 is coupled via an assembly, such as via adhesion, fastening, mating, interlocking, and other suitable technologies. However, in other embodiments, the line 124 is unitary with the side 106. Alternatively, the side 106 include a J-hook, which can be assembled, as described above, or be unitary.

A vertical member 902, such as a building sidewall, has a fastener 904 fastened thereto. The fastener 904 is defined via a cap 904.1 and a stem inserted into the member 902. The line 124 contacts the stem and extends over the stem such that the nail 100 hangs off the stem, with the cap 904.1 precluding the line 124 from sliding off the stem. In other embodiments, at least one end of the line 124 can include a plug, such as described above, for instance a USB plug. The plug can be used for plugging into other devices/peripherals for recharging and/or data transfer onto the module 112.

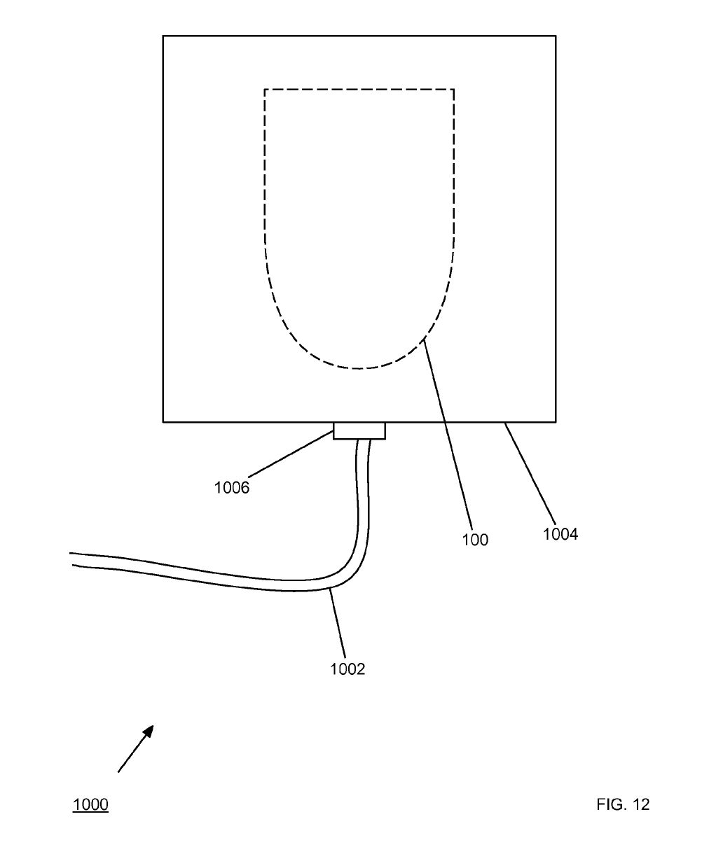

FIG. 12 shows an example embodiment of a case storing an artificial nail for charging according to the present disclosure. Some elements of this figure are described above. Thus, same reference characters identify identical and/or like components described above and any repetitive detailed description thereof will hereinafter be omitted or simplified in order to avoid complication.

A case 1000 includes a cord 1002 and a plug 1006 coupled to one end of the cord 1002. At the other end, the cord 1002 is coupled to a power source, such as a battery, a wall outlet, a mobile phone, a laptop computer, a car charger, and so forth. The cord 1002 conducts electricity from one end to another. The plug 1006 is a USB plug, but other technologies can also be used, such as described herein.

The case 1000 also includes a body 1004, which encases the nail 100. The body 1004 includes plastic, but can include other suitable materials, such wood, metal, rubber, glass, and so forth. The body 1004 is solid and rigid, but can be at least one of perforated and flexible. The body 1004 can be waterproof and shockproof. The body 1004 can be at least one of transparent, translucent, and opaque. The body 1004 can be shaped of any shape, such as a cube, a cuboid, a cone, a pyramid, a sphere, a spheroid, and so forth. The body 1004 can include a door, which can pivot open and closed for access to the nail 100.

The body 1004 receives the plug 1006 such that the body 1004 and the plug 1006 are in a male-female coupling relationship and that the nail 100 is recharged based on the electricity conducted via the cord 1002. Note that the cord 1002 can also feed data, such as visual information, video, audio, and so forth, to the memory unit of the module 112 of the nail 100. The nail 100 snugly rests within the body 1004 and the power source of the nail 100 is recharged via the body 1004. Note that such recharging can be in at least one of a wired manner and a wireless manner. In other embodiments, the body 1004 stores more than one nail 100, such as in a horizontal manner, a vertical manner, and so forth. In yet other embodiments, the case 1000 lacks the cord 1002 and the body 1004 includes an onboard power source, such as a battery, a capacitor, and so forth.

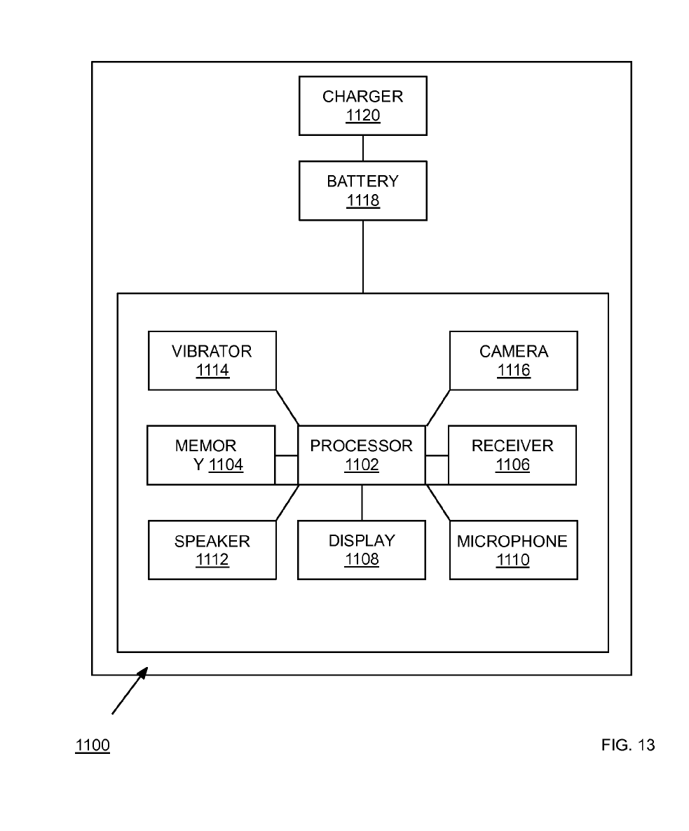

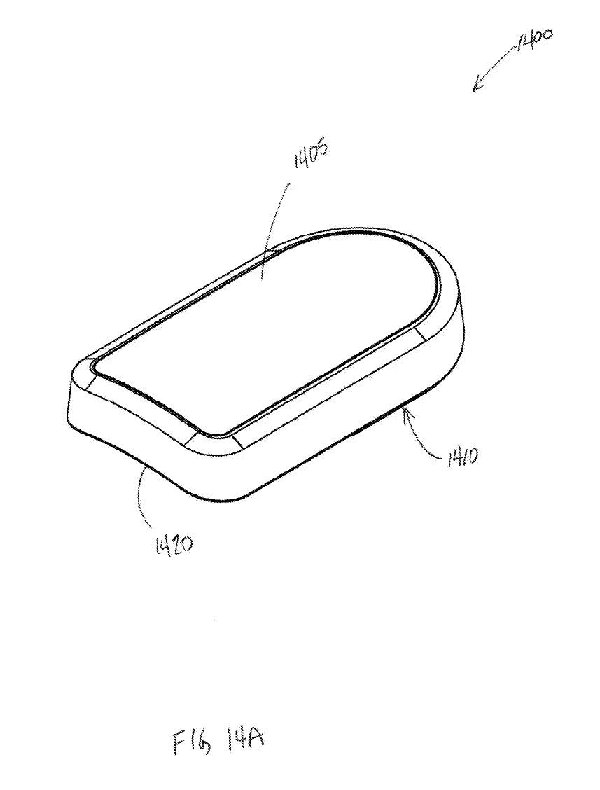

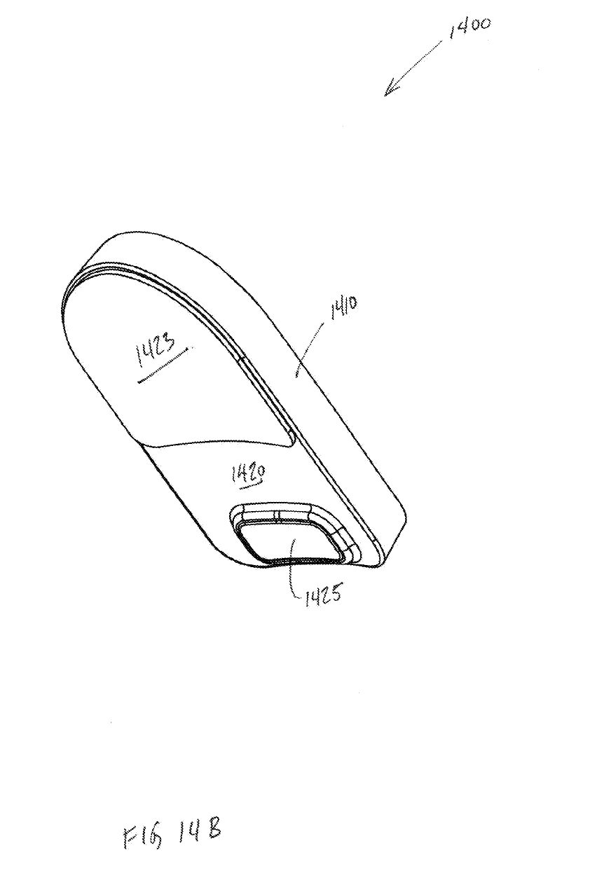

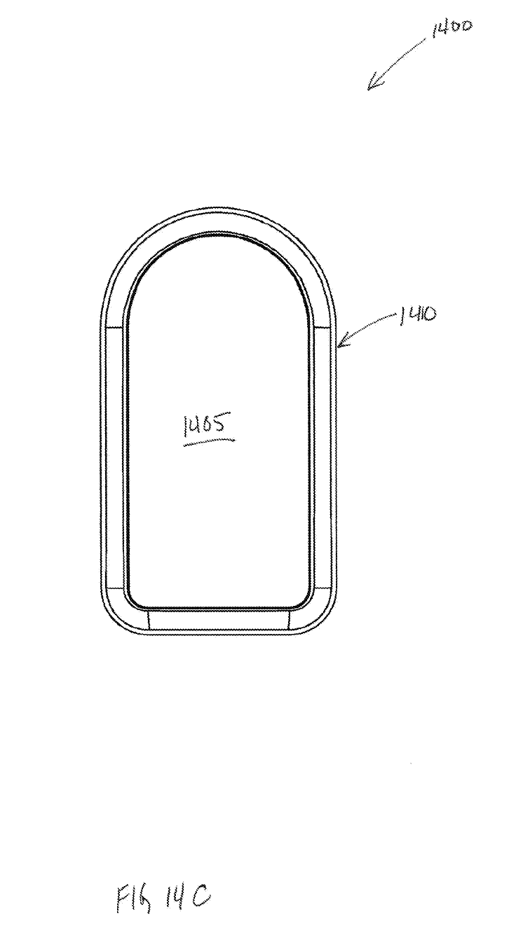

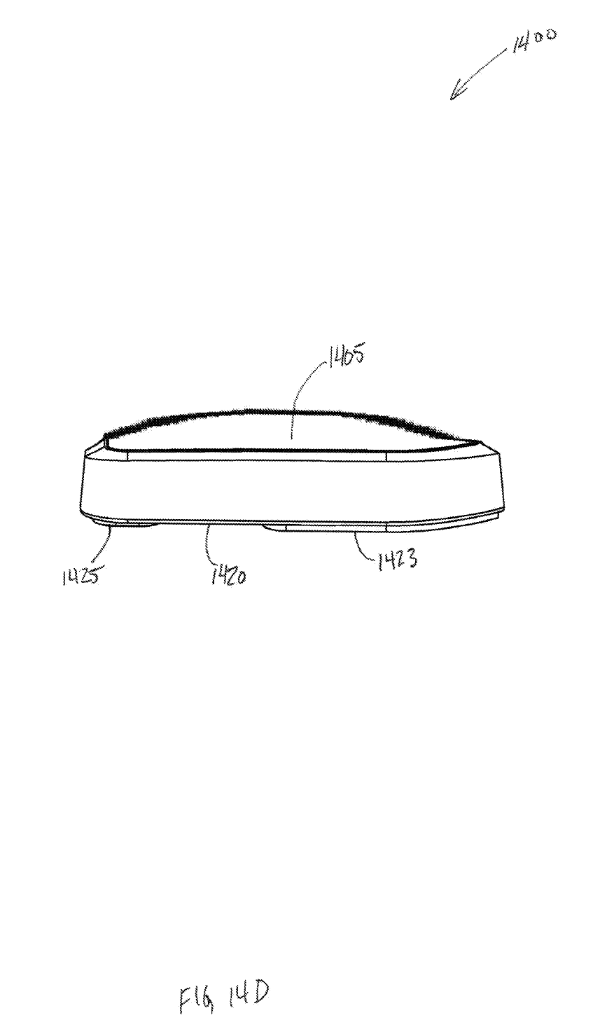

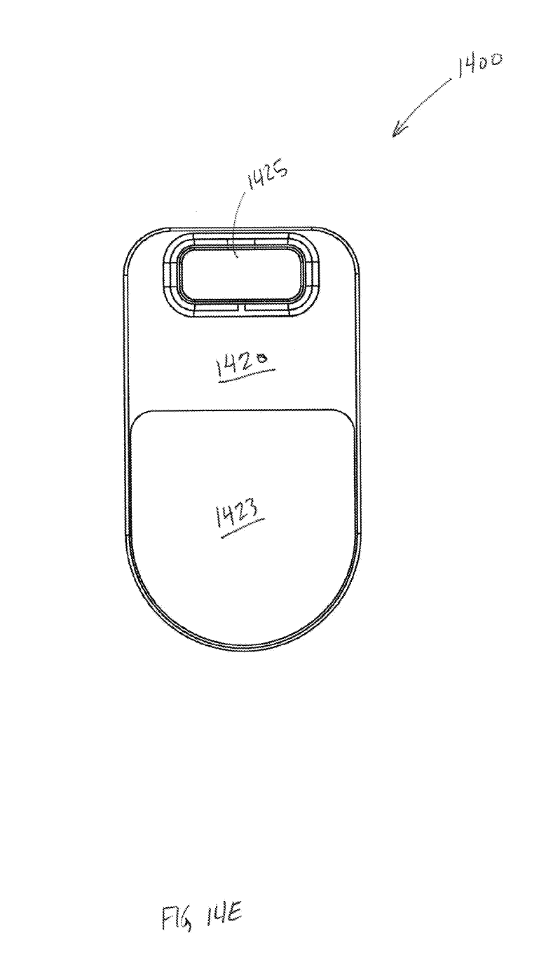

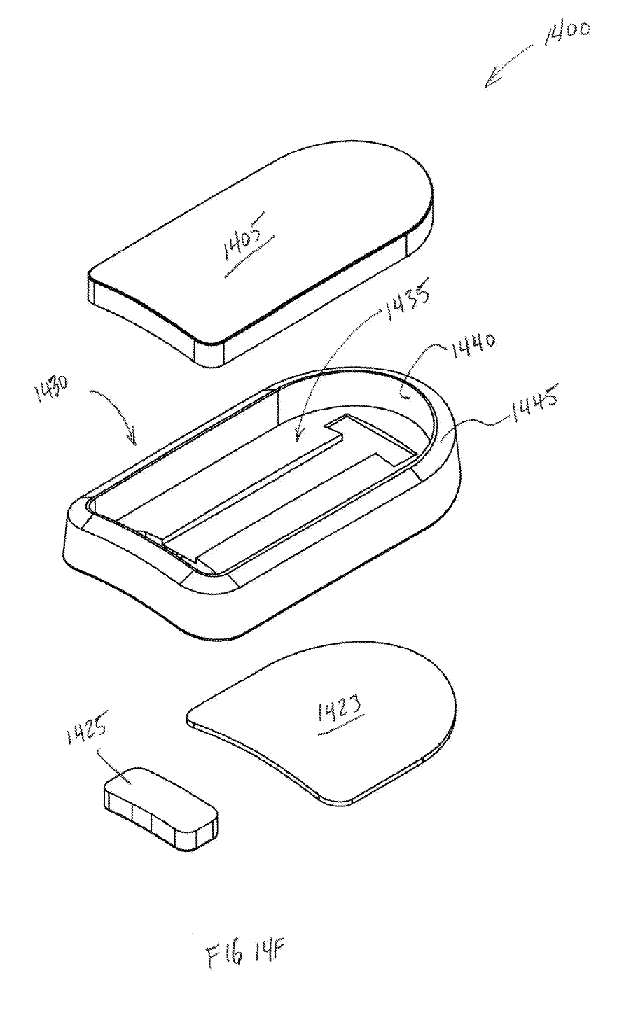

FIG. 13 shows a schematic diagram of an example embodiment of an artificial nail according to the present disclosure. Some elements of this figure are described above. Thus, same reference characters identify identical and/or like components described above and any repetitive detailed description thereof will hereinafter be omitted or simplified in order to avoid complication.

A schematic diagram 1100 of the nail 100 shows an onboard computing unit and an onboard power unit powering the computing unit. As described herein, the computing unit includes a processor 1102, a memory 1104, a receiver 1106, a display 1108, a microphone 1110, a speaker 1112, a vibrator 1114, and a camera 1116. As described herein, the power unit includes a battery 1118 and a charger 1120 charging the battery 1118.

The processor 1102 is operably coupled to the memory 1104, the receiver 1106, the display 1108, the microphone 1110, the speaker 1112, the vibrator 1114, and the camera 1116, as described herein. The battery 118 is recharged via the charger 1120, such as the element 122, the cell 116, a hand powered charging mechanism, and so forth. Such mechanism can operate similarly the mechanism of FIG. 9 except that the switch 120 functions as a manually pushed/pulled charging T-shaped lever operating against internal resistance, which generates energy.

Note that computing connections, as described herein, can include all direct and/or indirect types of communicative communication, whether wired, wirelessly, over a network, via a bus or any other computing structure. Also, connecting elements can permit for indirect connection. Further, note that communications as described herein can include unidirectional communication, bidirectional communication, multidirectional communication, and so forth.

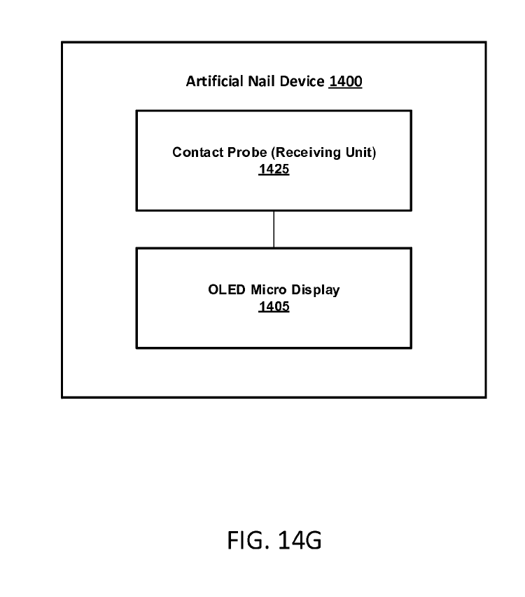

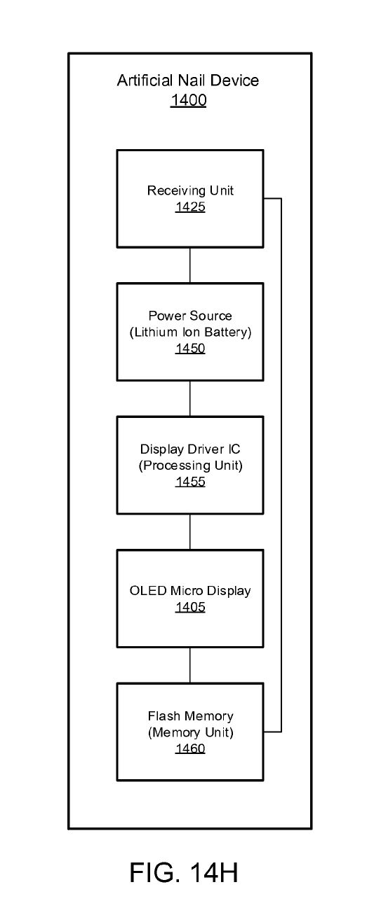

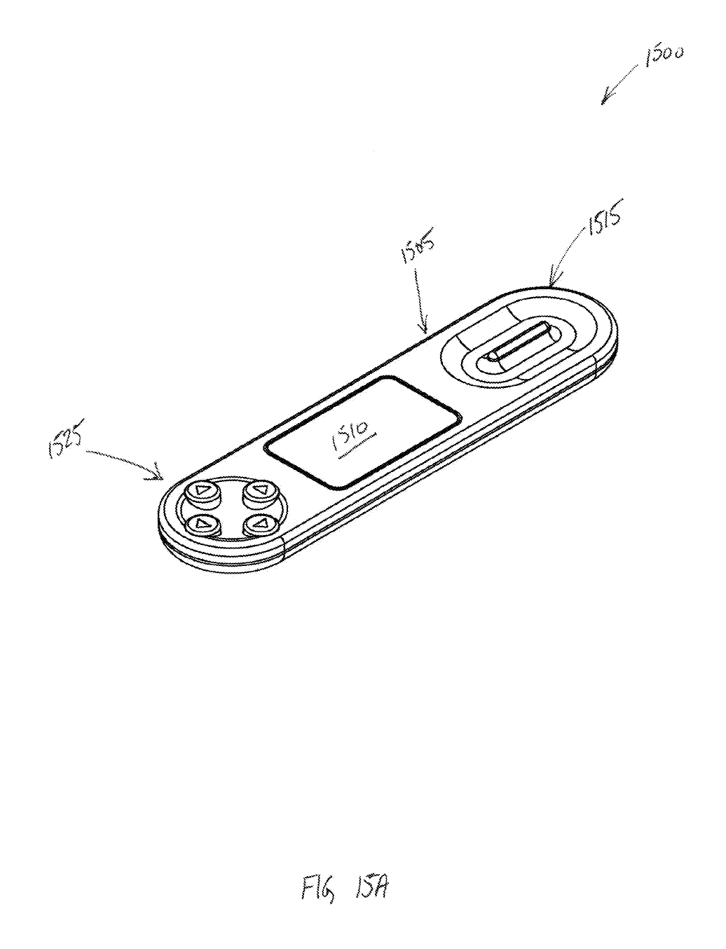

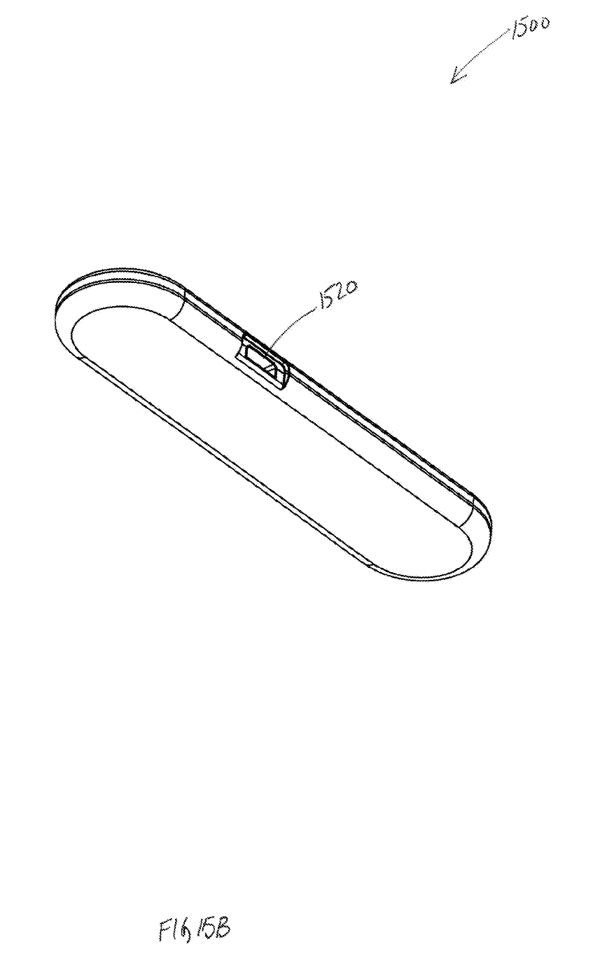

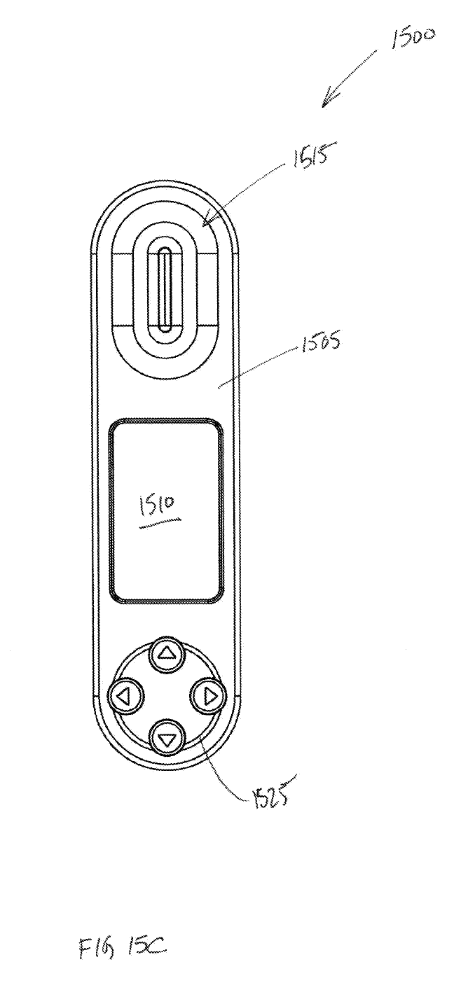

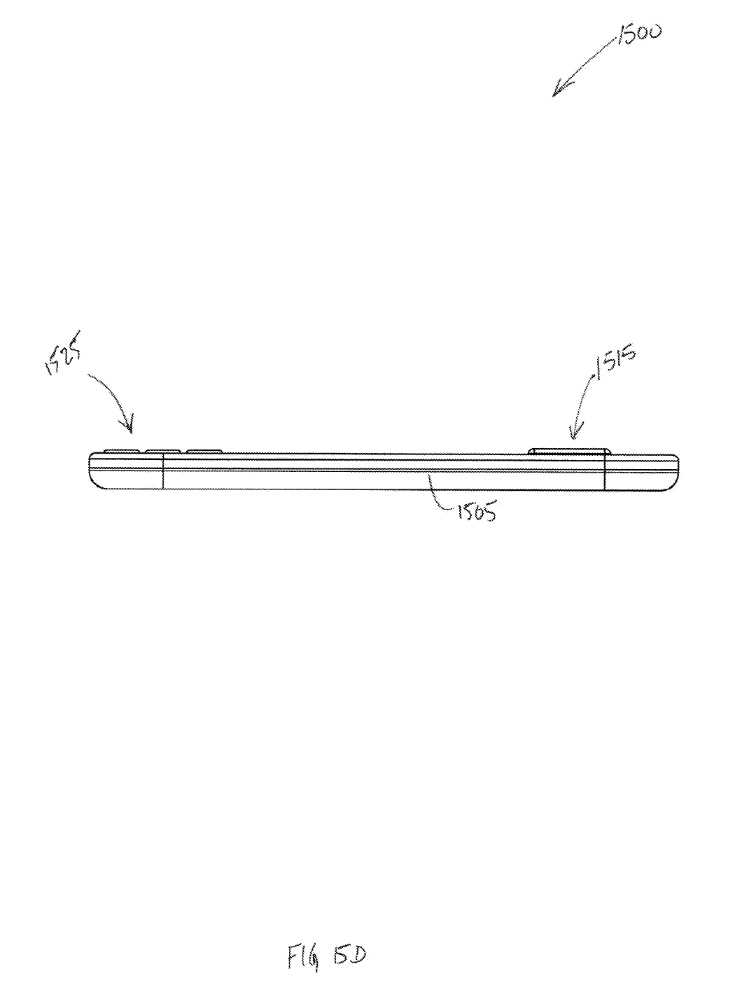

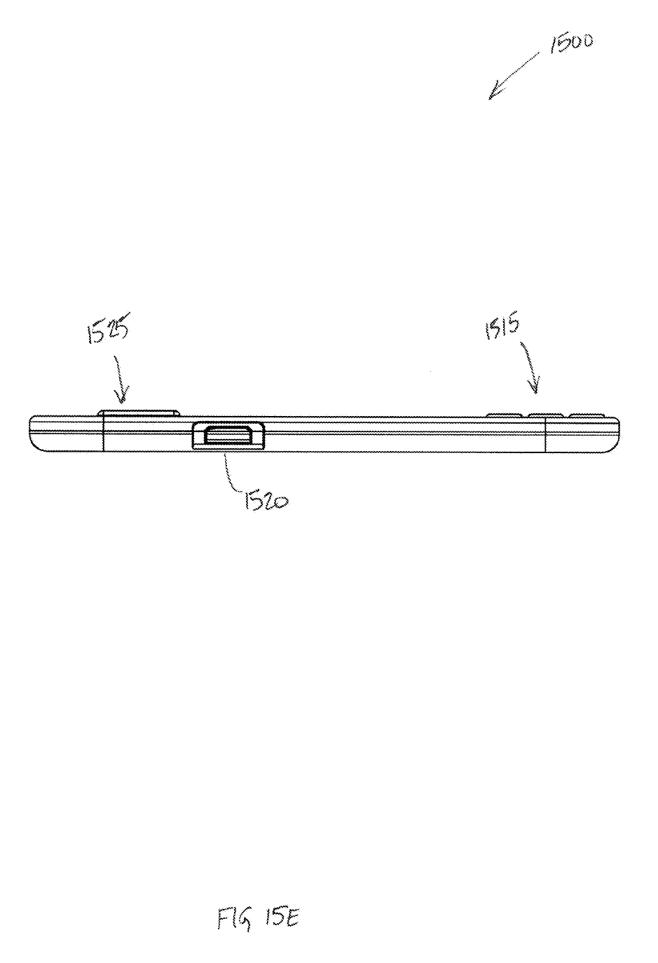

FIGS. 14A-G collectively illustrate another embodiment artificial nail device/nail covering device (hereinafter “device 1400”) that is constructed in accordance with the present technology. To be sure, the device 1400 is similar to the artificial nails described herein with the exception that a display 1405 of the device 1400 uses electrophoretic ink (also referred to as “e-ink”), as mentioned above.

The device 1400 generally comprises a body 1410 that is configured to mate with a fingernail of a user. In one embodiment, a lower surface 1420 of the body 1410 is curved to correspond to a fingernail of the user. In some embodiments the lower surface 1420 comprises a means for releasably or fixedly attaching the body 1410 to the fingernail of the user. In one embodiment an attachment means 1423 such as double sided tape is used, although an adhesive can also be utilized.

The device 1400 also comprises a receiving unit 1425 such as an electrical contact pad. The receiving unit 1425 allows the processing unit of the device 1400 to communicate with a design transfer device, which is described in greater detail below. The display 1405 is configured to receive one or more designs from the design transfer device through the receiving unit 1425.

In some embodiments the display 1405 associated with an upper surface 1430 of the body 1410. As mentioned above, the device uses electrophoretic ink to display designs. For context, electrophoretic ink (e-ink) is a type of an electronic paper that can be formed as a film. E-ink can mimics the appearance of physical ink on paper. Thus, the display 1405 can use e-ink to display designs on the artificial nail device 1400. In other embodiments, the display 1405 can use other types of electronic paper that allow for the display of colored designs as well as grayscale and/or black and white designs.

In FIG. 14F, an exploded view of the device 1400 is illustrated. The body 1410 comprises cavity 1435 that is sized to receive and retail the display 1405. The body 1410 includes a peripheral sidewall 1440 that defines a peripheral edge 1445. The peripheral sidewall 1440 defines the cavity 1435. In one embodiment, the peripheral edge 1445 is a bezel that restricts the display 1405 when installed into the cavity 1435 of the body 1410.

According to some embodiments, the display 1405 is provided with a scratch-proof layer that prevents damage to the display 1405. Also, the device 1400 is manufactured to be substantially or entirely water-resistant or water-proof.

Turning now to FIG. 14G, a schematic diagram of an example device 1400 is illustrated. The device 1400 would require only a e-ink display screen and a receiving unit for receiving the desired design. As mentioned above, e-ink is contemplated for use with the present technology. Advantageously, e-ink has a benefit in that once the a design has been loaded onto a display it does not need any power. E-ink displays are very durable and can be very small.

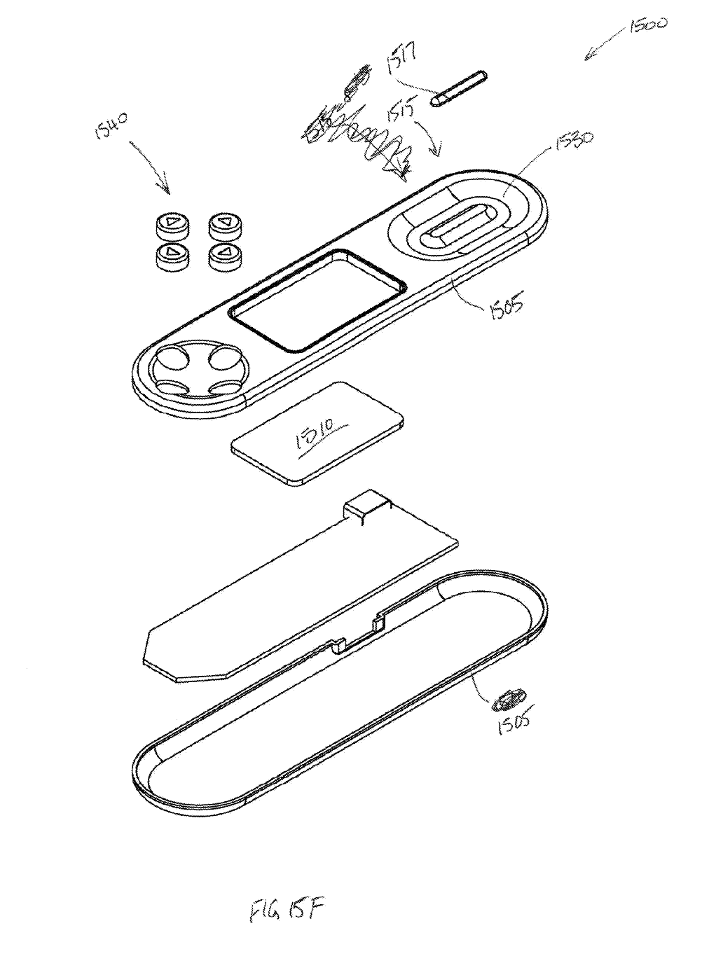

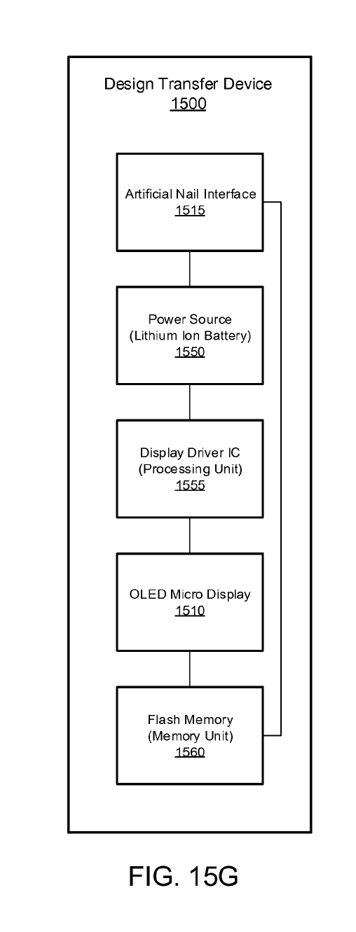

By incorporating the e-ink display into the nail the power, connection, driver and other supporting components, such as those described in FIG. 13 can all be incorporated into a separate unit that loads the image onto the nail, such as the design transfer unit. For example, all of the components required could be incorporated into a pen or nail-file like device that the user presses against the receiving unit 1425 of the device 1400. This action will upload the design to the device 1400 allowing the user to change the display 1405 as desired. The benefit of this is that power draw only occurs when the design updates meaning very little power is required to change the design and no power is needed once the design is loaded and displayed. Stated otherwise, the design transfer device 1500 of FIG. 15G uses power to transmit a design to the device 1400. The device 1400 receives the design through its receiving unit and the design is provided on the display 1405. No power is needed to power the display 1405. To be sure, the display is not actively requiring power to provide the design.

FIG. 14H illustrates another example device 1400 that comprises, in addition to the display 1405 and the receiving unit 1425, as well as a power source 1450, a display driver IC 1455, and a memory unit 1460. Thus, whereas the device in FIG. 14G comprises the display 1405 and the receiving unit 1425, the device in FIG. 14H additionally includes a power source, processor, and memory. To be sure, the embodiments of FIGS. 14G and 14H can be combined into a single embodiment.

In some embodiments, the power source 1450 comprises a lithium ion polymer battery, although other similar types of batteries can be used. Advantageously, small, thin batteries are preferable in some embodiments. In some embodiments, the display 1405 includes an OLED (organic light emitting diode) micro-display. Other flat or curved display units can also be utilized. In one embodiment, the memory unit 1460 is a flash memory, although other types of memory can likewise be utilized.

It will be understood that the receiving unit 1425 can be any electrical/communicative connector or interface that allows the device 1400 to receive power and design data.

Turning now to FIGS. 15A-G, an embodiment design transfer device is illustrated. The design transfer device 1500 is configured to transfer electronic designs to an artificial nail device, such as the device 1400 of FIGS. 14A-H. The transfer device 1500 generally comprises a housing 1505, a display 1510, an artificial nail interface 1515, an I/O port 1520, and a control panel 1525.

As with the artificial nail device, the transfer device 1500 also comprises a processing unit and a memory unit, as well as other components described in regard to FIG. 13. In some embodiments, one or more designs (or at least one design) is stored in the memory unit of the transfer device 1500. Systems and methods according to some embodiments for populating the transfer device 1500 with designs will be described in greater detail below.

The housing 1505 is configured such that the control panel 1525 is positioned below the display 1510 and the display is positioned below the artificial nail interface 1515. In one embodiment, the artificial nail interface 1515 is associated with a groove 1530 fabricated into the housing 1505. The nail interface 1515 can comprise, for example, an electrical contact pad 1517 that is similar to the electrical pad used on the device 1400.

In some embodiments, the groove 1530 is sized and configured to receive the at least a portion of the device 1400 of FIGS. 14A-H therein. For example, the display 1405 of the device 1400 can nest within the groove 1530. The device 1400 can be slid along the groove 1530 to effectuate bringing the interface 1515 and the receiving unit 1425 of the device 1400 into proximity for contact or contactless transfer of information (e.g., designs) therebetween.

Thus, in some embodiments, the transfer device 1500 is configured to transmit a design to the device 1400 (FIGS. 14A-H) using the artificial nail interface 1515 when the device 1400, and specifically the receiving unit 1425 is brought near the artificial nail interface 1515. As with the receiving unit 1425 of the device 1400, the artificial nail interface 1515 can include an electrical contact pad.

The display 1510 is configured to display designs selected by the user via the control panel 1525. In some embodiments, the control panel includes one or more buttons 1540 that allow the user to scroll or page through designs stored in the memory unit of the transfer device 1500.

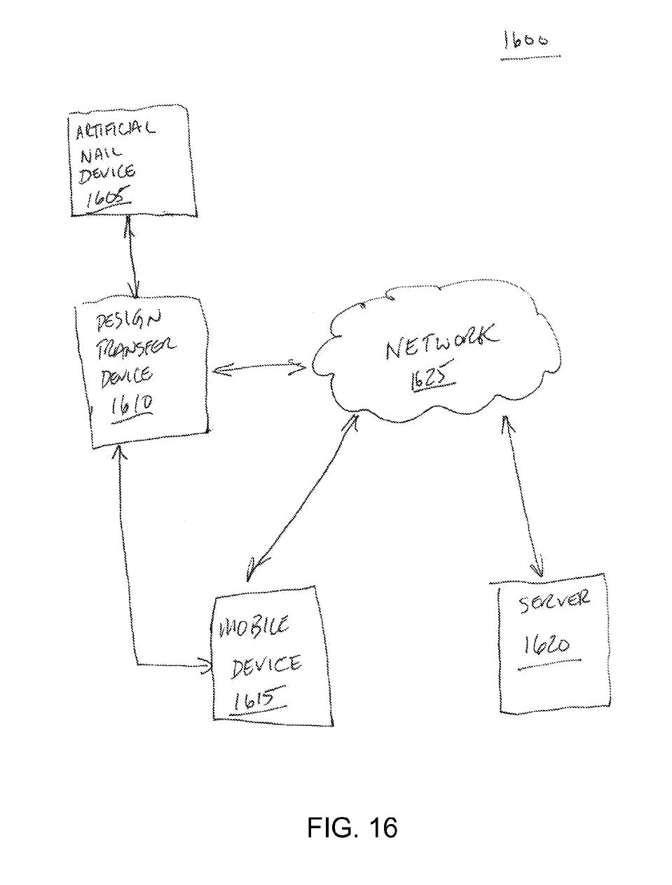

The transfer unit 1500 is also provided with the I/O port 1520, such as a USB port that allows the transfer device 1500 to communicatively couple with an external computing system to receive designs therefrom. To be sure, the transfer unit 1500 can use any suitable wired or wireless interface for effecting data transfer with an external computing system Embodiments of external computing systems are illustrated in FIG. 16, described below.

FIG. 15G is an example schematic diagram of a design transfer device 1500 that comprises the artificial nail interface 1515 and display 1510 described above. The device 1500 also includes a power source 1550, a display driver IC 1555 that controls the display 1510, and memory unit 1560. The transfer device 1500 can be used to transfer designs to the devices 1400 of FIGS. 14G and 14H. Again, the device 1400 of FIG. 14H is self powering, while the device 1400 of FIG. 14G requires power from the transfer device 1500 to change the display 1405 of the device 1400.

When the device 1400 of FIG. 14G, and specifically the receiving unit 1425 of the device 1425 is brought into contact with (or near) the artificial nail interface 1515, power from the power source 1550 activates the e-ink display 1405 of the device 1400. A design is transferred to the device 1400 through the receiving unit 1425 and is formatted for display on the e-ink display 1405. Again, no power is required for the e-ink display 1405 to maintain the display of the design on the e-ink display 1405 after the design has been displayed.

FIG. 16 illustrates an example system 1600 that can be used to practice aspects of the present technology. In one embodiment, the system 1600 comprises an artificial nail device 1605, a design transfer device 1610, a mobile device 1615, and a server 1620.

To be sure, the artificial nail device 1605 is the device 1400 of FIG. 14G and the design transfer device 1610 is the transfer device 1500 of FIG. 15G. The mobile device 1615 is configured, in some embodiments, to obtain and store designs that are capable of being stored on the transfer device 1610 and displayed on the display of the device 1605. The mobile device 1615 can execute an application that allows an end user to search, download, edit, or create digital designs that are to be displayed on the device 1605.

In one embodiment, the mobile device 1615 can obtain designs from the server 1620 over a wireless network such as a telecommunications network or the Internet, such as network 1625.

As mentioned above, the transfer device 1610 can receive designs from the mobile device 1615 using wired or wireless communications. In another exemplary embodiment, the mobile device 1615 can transfer designs to the device 1605 using the I/O port of the device 1605. The user can cause designs to be transferred to the transfer device 1610 using their mobile device 1615 using an application. The user can select one or more designs using the application on the mobile device 1615 and choose to transfer those designs to the transfer device 1610.

Thus, it will be appreciate that the application used by the mobile device 1615 provides various GUIs that allow the user to search, download, edit, or create digital designs.

The server 1620 communicatively couples with the design transfer device 1610 in some embodiments. The server 1620 stores a plurality of designs that can be downloaded by the user. In some embodiments, the transfer device 1610 can communicate directly with the server 1620 rather than depending on the mobile device 1615 as a middle device to effectuate design transfers from the server 1620 to the transfer device 1610. Also, in some embodiments, the device 11605 can receive designs for display directly from either the mobile device 1615 or the server 1620, rather than requiring the use of the transfer device 1610. In some embodiments, the mobile device can be a mobile phone.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. Other types of programming languages include HTML5, Flash and other similar languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams, as disclosed herein, illustrate the architecture, functionality and operation of possible implementations of systems, methods and computer program products according to various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical applications thereof, and to enable others of ordinary skill in the art to understand the disclosure for various embodiments with various modifications as are suited to the particular use contemplated. There may be many variations to this diagram or the steps (or operations) described therein without departing from the spirit of the disclosure. For instance, the steps may be performed in a differing order or steps may be added, deleted or modified. All of these variations are considered a part of the claimed disclosure. While the preferred embodiments to the disclosure had been described, skilled artisans, both now and in the future, may make various improvements and/or enhancements, which fall within the scope of the claims which follow. These claims should be construed to maintain the proper protection for the disclosure first described.

1.-20. (canceled)

21. A device, comprising:
a body configured to mate with a fingernail of a user; and
a display associated with an upper surface of the body that uses electrophoretic ink or electronic paper to display designs.

22. The device according to claim 21, further comprising a receiving unit for communicating with a design transfer device, wherein the display is configured to receive one or more designs from the design transfer device through the receiving unit.

23. The device according to claim 21, wherein a peripheral edge of the display includes a bezel.

24. The device according to claim 21, further comprising an adhesive substrate disposed on a surface of the body that is opposite the upper surface of the body.

25. The device according to claim 21, wherein the display comprises a scratch-proof layer.

26. A system, comprising:
a nail covering device, comprising:
a body configured to mate with a fingernail of a user;
a display associated with an upper surface of the body, the display using electrophoretic ink to display designs; and
a receiving unit for communicating with a design transfer device; and
the design transfer device comprising:
a housing that comprises a processing unit and memory unit for storing at least one design, wherein the design transfer device is configured to transmit the at least one design to the nail covering device.

26. The system according to claim 26, wherein a peripheral edge of the display includes a bezel.

27. The system according to claim 26, wherein the nail covering device further comprises an adhesive substrate disposed on a surface of the body that is opposite the upper surface of the body.

28. The system according to claim 26, wherein the display comprises a scratch-proof layer.

29. The system according to claim 26, wherein the housing comprises a groove that is configured to receive the nail covering device, the groove comprising an interface that is configured to cooperate with the interface of the nail covering device to allow for transfer of the at least one design from the design transfer device to the nail covering device.

30. The system according to claim 26, wherein the at least one design is transferred to the nail covering device when the nail covering device is slid within the groove of the housing of the design transfer device.

31. The system according to claim 26, wherein the design transfer device is configured to communicate with a mobile device and receive the at least one design from the mobile device.

32. (canceled)

33. A design transfer device comprising:
a housing that comprises a processing unit and memory unit for storing at least one design, wherein the design transfer device is configured to transmit the at least one design to a receiving unit of a nail covering device for displaying said design on an electrophoretic ink or electronic paper display carried on said nail covering device.
